(19) United States
(12) Patent Application Publication
(10) Pub. No.: US 2015/0181448 A1
(43) Pub. Date: Jun. 25, 2015

(54) MOBILE TERMINAL TEST DEVICE AND MOBILE TERMINAL TEST METHOD

(71) Applicant: ANRITSU CORPORATION, Atsugi-shi (JP)

(72) Inventors: Nobutoshi Otonari, Kanagawa (JP); Haruyuki Togashi, Kanagawa (JP)

(21) Appl. No.: 14/560,005

(22) Filed: Dec. 4, 2014

(30) Foreign Application Priority Data
Dec. 20, 2013 (JP) 2013-263355

(51) Int. Cl. H04W 24/08; H04W 72/04; H04L 5/14

(52) U.S. Cl. CPC H04W 24/08; H04L 5/14; H04W 72/042

(57) ABSTRACT

A mobile terminal test device includes a frame structure storage unit that stores a plurality of frame structure information items indicating the allocation patterns of a downlink (DL) and an uplink (UL) to a predetermined number of sub-frames forming one TDD frame, a scenario processing unit 24 including means for designating the type of frame used for a throughput test, and a timing control unit 27 that determines at least one of UL sub-frames in the designated type of frame as a response start sub-frame for returning acknowledgement/negative-acknowledgement messages from a mobile terminal 1 with reference to the frame structure information corresponding to the designated type of frame and determines at least one of DL sub-frames that are a predetermined number of sub-frames before the response start sub-frame as a transmission start sub-frame. The DL throughput of an arbitrarily designated type of frame is accurately calculated.

### TECHNICAL FIELD

The present invention relates to a technique for accurately measuring throughput when a time division duplex (TDD) mobile terminal receives downlink (hereinafter, referred to as DL) data from a base station.

### BACKGROUND ART

There are various test items for mobile terminals, such as mobile phones or smart-phones. Among the test items, an important test item is a throughput test for measuring throughput when DL data is received from a base station.

A test device which is a so-called pseudo base station device that communicates with the mobile terminal as a pseudo base station is used to test the mobile terminal. In the throughput test, the test device transmits user data to the mobile terminal in the DL and calculates throughput on the basis of the number of acknowledgement/negative-acknowledgement (hereinafter, referred to as ACK/NACK) messages which return from the mobile terminal in response to the user data in uplink (hereinafter, referred to as UL). In this case, the term “throughput” means the percentage (reception rate) of data whose reception is acknowledged by the mobile terminal among the data items which are transmitted from the test device in the DL.

A frequency division duplex (FDD) system that establishes the DL from the base station to the mobile terminal and the UL from the mobile terminal to the base station using different frequencies (for example, a frequency division duplex long term evolution (FDD-LTE) system) is defined as follows. As shown in FIG. 7, a DL frame using a frequency f1 and a UL frame using a frequency f2 have the same number of sub-frames and the sub-frames of the two types of frames are synchronized with each other. In addition, a signal in which user data items Da1 and Da2 are inserted into predetermined DL sub-frames is transmitted and then a signal in which ACK/NACK messages M1 and M2 for the user data items Da1 and Da2 are inserted into UL sub-frames after m (m is equal to or greater than 2) sub-frames is transmitted.

Therefore, when testing throughput, the test device starts to insert user data for a throughput test into predetermined DL sub-frames and counts the number of ACK/NACK messages inserted into UL sub-frames after m sub-frames to calculate throughput.

Patent Document 1 discloses a technique for measuring the DL throughput of a mobile terminal.

### RELATED ART DOCUMENT

### Patent Document

[Patent Document 1] Japanese Unexamined Patent Application Publication No. 2009-147640

### DISCLOSURE OF THE INVENTION

### Problem that the Invention is to Solve

As described above, in the FDD system in which a DL frame and a UL frame have different frequencies and the sub-frames of the DL frame and the UL frame are synchronized with each other, the number of ACK/NACK messages starts to be counted from the time that is delayed from a DL data transmission start time by m sub-frames to calculate throughput.

However, in the time division duplex (TDD) system (for example, the time division long term evolution (TD-LTE) system) in which the DL and the UL use the same frequency and bidirectional communication is performed in a time division manner, the DL and the UL are allocated to a predetermined number of sub-frames (for example, 10 sub-frames) forming one frame. The allocation pattern can be changed depending on, for example, a communication environment. Therefore, at a DL user data transmission start position for the throughput test, the time when the mobile terminal starts to return ACK/NACK messages as a response to the user data is not constant and it is difficult to acquire the ACK/NACK messages at an exact time and to measure throughput. As a result, there is a concern that an error will occur in the measurement result.

An object of the invention is to solve the above-mentioned problems and to provide a mobile terminal test device and a mobile terminal test method which can measure the DL throughput of a TDD mobile terminal with high accuracy.

### Means for Solving the Problem

In order to achieve the object, according to a first aspect of the invention, there is provided a mobile terminal test device that tests downlink throughput of a mobile terminal using a time division duplex system in which one frame is divided into a predetermined number of sub-frames in a time division manner and a downlink and an uplink are allocated to the sub-frames. The mobile terminal test device includes: a frame structure storage unit (26) that stores a plurality of frame structure information items indicating allocation patterns of the predetermined number of sub-frames forming the one frame to a downlink and an uplink so as to correspond to a plurality of different allocation patterns; frame type designation means (24) for designating the type of frame used for the throughput test; and a timing control unit (27) that determines, as a response start sub-frame for returning acknowledgement/negative-acknowledgement messages for user data received by the mobile terminal, at least one of the sub-frames allocated to the uplink in the frame which is indicated by frame structure information corresponding to the type of frame designated by the frame type designation means among the plurality of frame structure information items stored in the frame structure storage unit, with reference to the frame structure information, and determines, as a transmission start sub-frame for starting transmission of user data used for the throughput test, at least one of the sub-frames, which is a predetermined number of sub-frames before the determined response start sub-frame and is allocated to the downlink. The user data is inserted into the transmission start sub-frame determined by the timing control unit and is transmitted to the mobile terminal. The acknowledgement/negative-acknowledgement messages which are returned from the mobile terminal that has received the user data by the determined response start sub-frame are counted to calculate the throughput.

According to a second aspect of the invention, in the mobile terminal test device according to the first aspect, the timing control unit may store information indicating the position of a sub-frame corresponding to the response start sub-frame from the response start sub-frame for each type of frame in advance.

According to a third aspect of the invention, in the mobile terminal test device according to the first aspect, the frame type designation means may be a portion of a scenario processing unit that stores a scenario for defining an overall test procedure of the mobile terminal test device in advance and performs all processes of the mobile terminal test device according to the scenario, and may designate the type of frame used for the throughput test according to the scenario.

According to a fourth aspect of the invention, in the mobile terminal test device according to the first aspect, the time division duplex system may be a TD-LTE system.

According to a fifth aspect of the invention, there is provided a mobile terminal test method that tests downlink throughput of a mobile terminal using a time division duplex system in which one frame is divided into a predetermined number of sub-frames in a time division manner and a downlink and an uplink are allocated to the sub-frames. The mobile terminal test method includes: a step of storing a plurality of frame structure information items indicating allocation patterns of the predetermined number of sub-frames forming the one frame to the downlink and the uplink so as to correspond to a plurality of different allocation patterns; a step of designating the type of frame used for the throughput test; and a step of determining, as a response start sub-frame for returning acknowledgement/negative-acknowledgement messages for user data received by the mobile terminal, at least one of the sub-frames allocated to the uplink in the frame which is indicated by frame structure information corresponding to the designated type of frame among the stored plurality of frame structure information items, with reference to the frame structure information, and determining, as a transmission start sub-frame for starting transmission of user data used for the throughput test, at least one of the sub-frames, which is a predetermined number of sub-frames before the determined response start sub-frame and is allocated to the downlink. The user data is inserted into the determined transmission start sub-frame and is transmitted to the mobile terminal. The acknowledgement/negative-acknowledgement messages which are returned from the mobile terminal that has received the user data by the determined response start sub-frame are counted to calculate the throughput.

According to a sixth aspect of the invention, in the mobile terminal test method according to the fifth aspect, the step of determining the sub-frame as the sub-frame for starting the transmission of the user data used for the throughput test may include a step of storing information indicating the position of a sub-frame corresponding to the response start sub-frame from the response start sub-frame for each type of frame in advance.

According to a seventh aspect of the invention, in the mobile terminal test method according to the fifth aspect, the step of designating the type of frame used for the throughput test may be a portion of a step of storing a scenario for defining an overall procedure of the mobile terminal test method in advance and performing all processes of the mobile terminal test method according to the scenario, and may designate the type of frame used for the throughput test according to the scenario.

According to an eighth aspect of the invention, in the mobile terminal test method according to the fifth aspect, the time division duplex system may be a TD-LTE system.

### Advantage of the Invention

As such, in the invention, in the time division duplex system, a plurality of frame structure information items indicating allocation patterns of a predetermined number of sub-frames forming one frame to a downlink and an uplink are stored so as to correspond to a plurality of different allocation patterns. When the type of frame used for a throughput test is designated, at least one of the sub-frames allocated to the uplink in the frame which is indicated by frame structure information corresponding to the designated type of frame among the stored plurality of frame structure information items is determined as a response start sub-frame for returning acknowledgement/negative-acknowledgement messages for user data received by a mobile terminal, with reference to the frame structure information. In addition, at least one of the sub-frames, which are a predetermined number of sub-frames before the determined response start sub-frame and are allocated to the downlink, is determined as a sub-frame for starting transmission of user data used for the throughput test. The user data is inserted into the determined transmission start sub-frame and is transmitted to the mobile terminal. The acknowledgement/negative-acknowledgement messages which are returned from the mobile terminal that has received the user data by the determined response start sub-frame are counted to calculate throughput.

Therefore, even when any one of a plurality of types of frame structures used for testing the throughput of a TDD mobile terminal is designated, it is possible to receive acknowledgement/negative-acknowledgement messages which are returned from a mobile terminal by a desired uplink sub-frame in response to user data transmitted to the mobile terminal and to accurately test the downlink throughput of the mobile terminal.

### BRIEF DESCRIPTION OF THE DRAWINGS

FIG. 1 is a diagram illustrating the structure of an embodiment of the invention.

FIG. 2 is a diagram illustrating the type of TDD frame structure.

FIG. 3 is a diagram illustrating a process for one frame structure.

FIG. 4 is a diagram illustrating a process for another frame structure.

FIG. 5 is a diagram illustrating the correspondence relationship between a response start position and a transmission start position relative to the response start position in each frame structure.

FIG. 6 is a flowchart illustrating a process procedure of the embodiment of the invention.

FIG. 7 is a diagram illustrating an FDD throughput test.

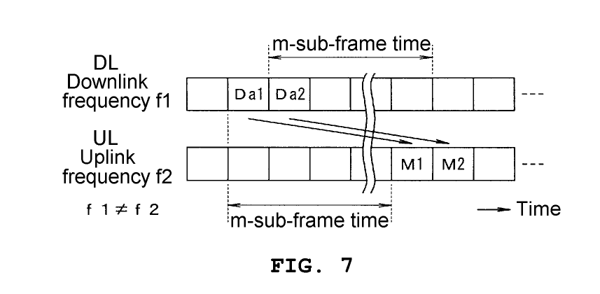

### BEST MODE FOR CARRYING OUT THE INVENTION

Hereinafter, an embodiment of the invention will be described with reference to the drawings.

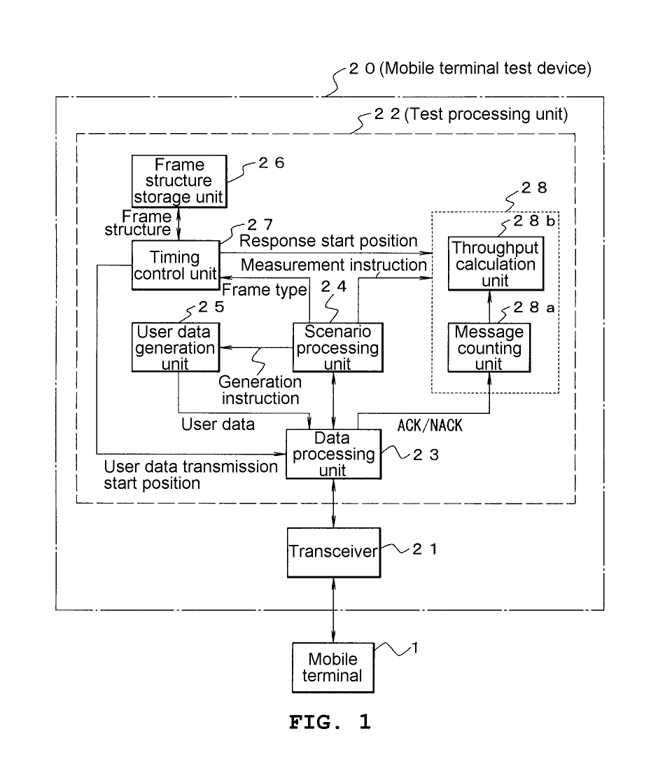

FIG. 1 is a diagram illustrating the overall structure of a mobile terminal test device (hereinafter, simply referred to as a test device) 20 according to the invention.

The test device 20 tests the DL throughput of a mobile terminal 1 using a time division duplex (TDD) system in which one frame is divided into a predetermined number of sub-frames in a time division manner and a DL and a UL are allocated to the sub-frames, and includes a transceiver 21 and a test processing unit 22. In a TD-LTE system, the one frame is called a radio frame. However, in this embodiment, the one frame is simply referred to as a frame.

The transceiver 21 transmits a radio-frequency signal which is modulated with a data signal from the test processing unit 22 to the mobile terminal 1 to be tested, receives a radio-frequency signal from the mobile terminal 1, and demodulates the received radio-frequency signal, and transmits the obtained data signal to the test processing unit 22.

The test processing unit 22 serves as a pseudo base station and communicates with the mobile terminal 1 through the transceiver 21 to perform various tests for the mobile terminal 1. Here, the test processing unit 22 is a main component required to test the DL throughput of the mobile terminal 1.

The test processing unit 22 includes a data processing unit 23, a scenario processing unit 24, a user data generation unit 25, a frame structure storage unit 26, a timing control unit 27, and a throughput measurement unit 28.

The data processing unit 23 inserts user data which is output from the user data generation unit 25 into a DL sub-frame at a predetermined time notified by the timing control unit 27 and transmits the user data as transmission data to the transceiver 21. The data processing unit 23 extracts ACK/NACK messages which are required to measure throughput from the data received from the transceiver 21 and transmits the ACK/NACK messages to the throughput measurement unit 28. In addition, the data processing unit 23 inserts control data transmitted from the scenario processing unit 24 into the transmission data and outputs the control data. The data processing unit 23 extracts the control data from the data which is received from the transceiver 21 and transmits the control data to the scenario processing unit 24.

The scenario processing unit 24 stores a scenario that defines the overall test procedure of the test device 20 in advance and performs, for example, a process of transmitting and receiving the control data, which is required for connection with the mobile terminal 1 or a throughput test, to and from the mobile terminal 1, a process of instructing the user data generation unit 25 to generate data, a process of notifying the timing control unit 27 of the type of frame structure (frame type designation means), and a process of instructing the throughput measurement unit 28 to measure throughput, according to the procedure.

The user data generation unit 25 generates DL user data used for the throughput test in response to a data generation instruction from the scenario processing unit 24.

The frame structure storage unit 26 stores in advance a plurality of frame structure information items indicating the allocation patterns of a predetermined number of sub-frames forming the frame used for the throughput test to the downlink and the uplink so as to correspond to a plurality of different allocation patterns.

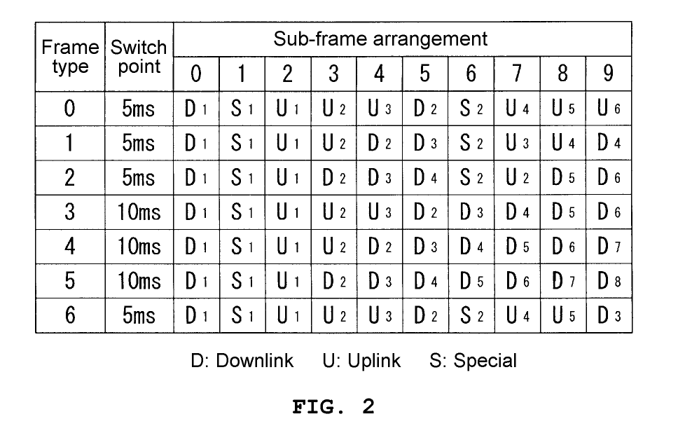

FIG. 2 shows seven types of frames used in the TD-LTE system, in which letter U indicates a UL sub-frame, letter D indicates a DL sub-frame, and letter S indicates a special sub-frame. A DL portion (DwPTS) is arranged before the special sub-frame S, with a gap therebetween, and a UL portion (UpPTS) is arranged after the special sub-frame S, with a gap therebetween. In the throughput test, the special sub-frame S is treated as the DL sub-frame which transmits the user data using the DL portion.

As can be seen from FIG. 2, the structures of the frames are mainly classified into two types, that is, a type in which one special sub-frame S is present among 10 sub-frames (10 ms) (switch point interval: 10 ms) and a type in which two special sub-frames S are present at an interval of 5 ms among 10 sub-frames (switch point interval: 5 ms). The two types have different allocation patterns of the sub-frames D and L.

The scenario processing unit 24 designates the frame to be used among the seven types of frames with different structures according to the scenario. It takes time to perform processing, such as data demodulation or error checking, until the mobile terminal 1 which has received the user data inserted into the DL sub-frame (include the DL portion of the special sub-frame S) returns the ACK/NACK messages for the user data.

Therefore, for example, even when the sub-frame immediately after the DL sub-frame having the user data inserted thereinto is a UL sub-frame, it is difficult to return the ACK/NACK messages with the UL sub-frame and it is necessary to wait for a response with the next UL sub-frame. In addition, the structure of the frame used for the test is arbitrarily changed by the designation of the scenario processing unit 24. Therefore, after the DL sub-frame having the user data inserted thereinto is transmitted, the time of the UL where a response to the user data is obtained is not fixed.

In order to respond to the above, the timing control unit 27 determines, as a response start sub-frame, at least one sub-frame, by which the ACK/NACK messages for the user data to be transmitted is returned from the mobile terminal 1, among the UL sub-frames of the designated frame structure with reference to information about the frame structure corresponding to the type of frame designated by the scenario processing unit 24 among the frame structures stored in the frame structure storage unit 26, and determines, as a user data transmission start sub-frame, the DL sub-frame for returning the ACK/NACK messages with the response start sub-frame.

The timing information of the transmission start sub-frame determined by the timing control unit 27 is notified to the data processing unit 23 and the timing information of the response start sub-frame is notified to the throughput measurement unit 28.

The throughput measurement unit 28 includes a message counting unit 28a that starts to count the ACK/NACK messages from the time notified by the timing control unit 27 and a throughput calculation unit 28b that calculates throughput from the count result, and calculates the DL throughput TP of the mobile terminal 1 to be tested.

When the count result of the ACK messages is A and the count result of the NACK messages is N, the throughput TP is as follows:

TP (%)=100×A/(A+N).

The calculated throughput TP is displayed on, for example, a display unit (not illustrated).

Next, the relationship between the UL sub-frame that receives the ACK/NACK messages returned from the mobile terminal 1 and the transmission start DL sub-frame that uses the UL sub-frame as a response start position will be described.

For example, in frame type 5 shown in FIG. 2, since one frame includes only one UL sub-frame U₁, the ACK/NACK messages are returned by using only the sub-frame U₁.

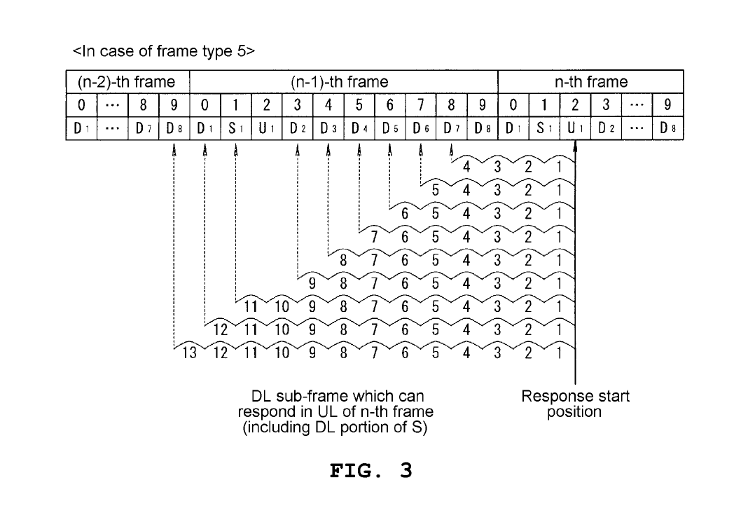

As shown in FIG. 3, in order to return the ACK/NACK messages with the UL sub-frame U₁ in an n-th frame, the mobile terminal 1 uses a DL sub-frame that is at least four sub-frames before the UL sub-frame U₁. That is, it is necessary to use at least one of the first to seventh DL sub-frames D₁ to D₇ and a special sub-frame S₁ in an (n−1)-th frame that is one frame before the n-th frame and an eighth DL sub-frame D₈ in an (n−2)-th frame before the (n−1)-th frame.

That is, the fourth to ninth sub-frames and the eleventh to thirteenth sub-frames in reverse chronological order from the response start UL sub-frame are candidates of the transmission start DL sub-frame into which the user data can be inserted.

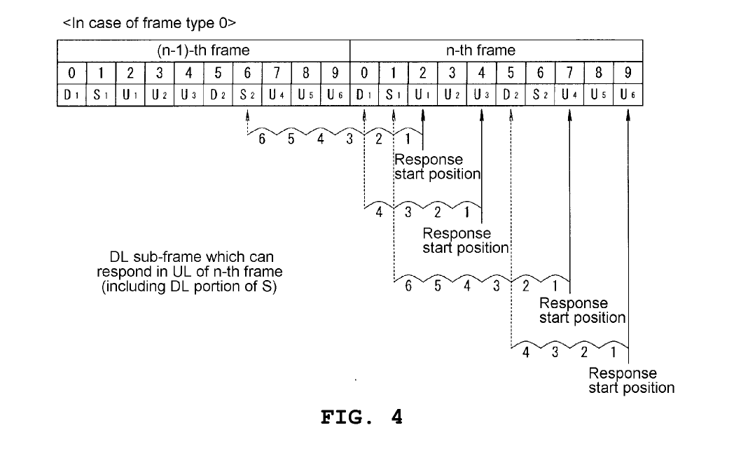

For example, in frame type 0 shown in FIG. 2, when the mobile terminal 1 uses a first UL sub-frame U₁ in an n-th frame as the response start sub-frame as shown in FIG. 4, a special sub-frame S₂ in an (n−1)-th frame that is one frame before the n-th frame can be used as the user data transmission start sub-frame. When a third UL sub-frame U₃ in the n-th frame is used as the response start sub-frame, the first DL sub-frame D₁ in the n-th frame can be used as the user data transmission start sub-frame. When a fourth UL sub-frame U₄ in the n-th frame is used as the response start sub-frame, a first special sub-frame S₁ in the n-th frame can be used as the user data transmission start sub-frame. When a sixth UL sub-frame U₆ in the n-th frame is used as the response start sub-frame, a second DL sub-frame D₂ in the n-th frame can be used as the user data transmission start sub-frame.

That is, the DL sub-frames and the special sub-frame that are four to thirteen sub-frames before the UL sub-frame for receiving the ACK/NACK messages are the candidates of the user data transmission start sub-frame.

In order to accurately calculate throughput in practice, it is preferable to use a large amount of user data. The test is performed with the highest accuracy by using all of the DL sub-frames (including the special sub-frames) into which data will be inserted to transmit the user data and by returning the ACK/NACK messages from the mobile terminal 1 with the UL sub-frame in response to all user data.

That is, in frame type 5 shown in FIG. 3, among the fourth to thirteenth sub-frames in the reverse chronological order from the response start position, the user data may be transmitted using all sub-frames except for the tenth UL sub-frame, the ACK/NACK messages for all of the user data may be received using one UL sub-frame U₁, and throughput may be calculated from the cumulative total value of the ACK/NACK messages. In frame type 0 shown in FIG. 4, the user data may be transmitted using the sub-frame S₂ in the (n−1)-th frame and the sub-frames S₁, D₁, and D₂ in the n-th frame and throughput may be calculated from the cumulative total value of the ACK/NACK messages which are returned by each of the sub-frames, using all of four response start positions U₁, U₃, U₄, and U₆.

In addition, in order to increase the amount of data, the above-mentioned process may be performed the number of times corresponding to a plurality of frames and throughput may be calculated using the cumulative total value of the messages.

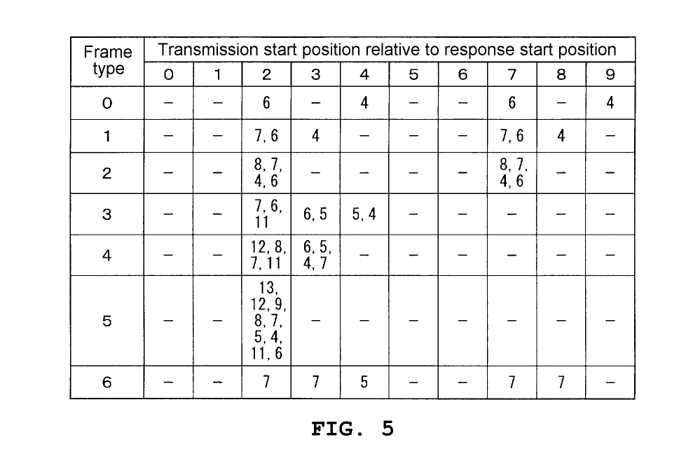

FIG. 5 shows the above-mentioned relationship and also shows the position of the sub-frames (the DL sub-frames and the special sub-frames S) to be preferably used as the user data transmission start sub-frames from the response start UL sub-frame for receiving the ACK/NACK messages in reverse chronological order in seven types of frame structures.

The timing control unit 27 stores the relationship between shown in FIG. 5 in advance, determines the response start sub-frame for obtaining the ACK/NACK messages among the UR sub-frames in the type of frame structure designated by the scenario processing unit 24, with reference to the type of frame structure, calculates the user data transmission start sub-frame for receiving the ACK/NACK messages with the determined response start sub-frame, notifies the data processing unit 23 of the timing information of the transmission start sub-frame, and notifies the throughput measurement unit 28 of the timing information of the response start sub-frame.

Therefore, when the tester records test conditions on the scenario processing unit 24, the response start UL sub-frame which is most suitable for the structure of a desired frame and the transmission start sub-frame are determined by only a process of designating the type of desired frame. It is possible to reliably perform the throughput test using the formed sub-frames.

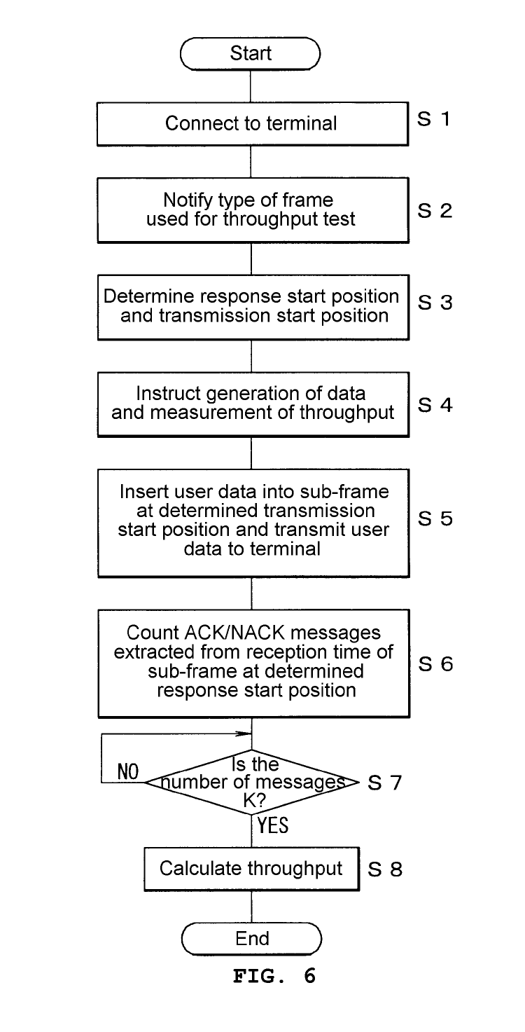

FIG. 6 is a flowchart illustrating the process procedure of the test processing unit 22 of the test device 20. Next, the operation of the test device 20 will be described with reference to the flowchart.

First, the scenario processing unit 24 transmits and receives various kinds of control data to and from the mobile terminal 1 to establish a call connection and a data communication channel (S1).

Then, the scenario processing unit 24 notifies the timing control unit 27 of the type of frame used for the throughput test (S2).

When receiving the notification, the timing control unit 27 determines the UL sub-frame which will be a response start position on the basis of the notified type of frame structure and notifies the throughput measurement unit 28 of the UL sub-frame. In addition, the timing control unit 27 determines the sub-frame which will be a user data transmission start position corresponding to the UL sub-frame and notifies the data processing unit 23 of the sub-frame (S3).

Then, the scenario processing unit 24 transmits a data generation instruction to the user data generation unit 25 and transmits a measurement start instruction to the throughput measurement unit 28 (S4).

In response to the instruction, the user data generation unit 25 outputs user data without an error, which is used for the throughput test, to the data processing unit 23. The data processing unit 23 inserts the user data into the transmission start sub-frame notified by the timing control unit 27 among the DL sub-frames in a predetermined frame which is used for communication with the mobile terminal 1 and transmits the user data to the transceiver 21. The transceiver 21 transmits the user data to the mobile terminal 1 to be tested (S5).

When receiving the user data, the mobile terminal 1 performs an error check (CRC) process on the received user data. When there is no error in the user data, the mobile terminal 1 inserts the ACK message into a UL sub-frame that is disposed at a predetermined position from the sub-frame, by which the user data is received, in chronological order and returns the ACK message. When there is an error in the user data, the mobile terminal 1 inserts the NACK message in the UL sub-frame and returns the NACK message.

The message which is returned from the mobile terminal 1 by the UL sub-frame is transmitted to the throughput measurement unit 28 through the transceiver 21 and the data processing unit 23. The throughput measurement unit 28 starts to count the number of ACK/NACK messages from the reception time of the response start sub-frame notified by the timing control unit 27. For example, when the sum A+N reaches a predetermined value K (the number of data items transmitted), the throughput measurement unit 28 calculates the throughput TP using the count values A and N (S6 to S8).

According to this structure, the test device 20 according to the embodiment enables the tester to accurately measure the DL throughput of the TDD mobile terminal 1, without performing a complicated process of setting a test procedure considering the relationship between the response time of the ACK/NACK messages and the transmission time of the user data according to the type of frames.

### DESCRIPTION OF REFERENCE NUMERALS AND SIGNS

1: MOBILE TERMINAL
20: MOBILE TERMINAL TEST DEVICE
21: TRANSCEIVER
22: TEST PROCESSING UNIT
23: DATA PROCESSING UNIT
24: SCENARIO PROCESSING UNIT
25: USER DATA GENERATION UNIT
26: FRAME STRUCTURE STORAGE UNIT
27: TIMING CONTROL UNIT
28: THROUGHPUT MEASUREMENT UNIT
28a: MESSAGE COUNTING UNIT
28b: THROUGHPUT CALCULATION UNIT

What is claimed is:

1. A mobile terminal test device that tests downlink throughput of a mobile terminal using a time division duplex system in which one frame is divided into a predetermined number of sub-frames in a time division manner and a downlink and an uplink are allocated to the sub-frames, comprising:
a frame structure storage unit that stores a plurality of frame structure information items indicating allocation patterns of the predetermined number of sub-frames forming the one frame to the downlink and the uplink so as to correspond to a plurality of different allocation patterns;
frame type designation means for designating the type of frame used for the throughput test; and
a timing control unit that determines, as a response start sub-frame for returning acknowledgement/negative-acknowledgement messages for user data received by the mobile terminal, at least one of the sub-frames allocated to the uplink in the frame which is indicated by frame structure information corresponding to the type of frame designated by the frame type designation means among the plurality of frame structure information items stored in the frame structure storage unit, with reference to the frame structure information, and determines, as a transmission start sub-frame for starting transmission of user data used for the throughput test, at least one of the sub-frames, which is a predetermined number of sub-frames before the determined response start sub-frame and is allocated to the downlink,
wherein the user data is inserted into the transmission start sub-frame determined by the timing control unit and is transmitted to the mobile terminal, and
the acknowledgement/negative-acknowledgement messages which are returned from the mobile terminal that has received the user data by the determined response start sub-frame are counted to calculate the throughput.

2. The mobile terminal test device according to claim 1,
wherein the timing control unit stores information indicating the position of a sub-frame corresponding to the response start sub-frame from the response start sub-frame for each type of frame in advance.

3. The mobile terminal test device according to claim 1,
wherein the frame type designation means is a portion of a scenario processing unit that stores a scenario for defining an overall test procedure of the mobile terminal test device in advance and performs all processes of the mobile terminal test device according to the scenario, and designates the type of frame used for the throughput test according to the scenario.

4. The mobile terminal test device according to claim 1,
wherein the time division duplex system is a TD-LTE system.

5. A mobile terminal test method that tests downlink throughput of a mobile terminal using a time division duplex system in which one frame is divided into a predetermined number of sub-frames in a time division manner and a downlink and an uplink are allocated to the sub-frames, comprising:
a step of storing a plurality of frame structure information items indicating allocation patterns of the predetermined number of sub-frames forming the one frame to the downlink and the uplink so as to correspond to a plurality of different allocation patterns;
a step of designating the type of frame used for the throughput test; and
a step of determining, as a response start sub-frame for returning acknowledgement/negative-acknowledgement messages for user data received by the mobile terminal, at least one of the sub-frames allocated to the uplink in the frame which is indicated by frame structure information corresponding to the designated type of frame among the stored plurality of frame structure information items, with reference to the frame structure information, and determining, as a transmission start sub-frame for starting transmission of user data used for the throughput test, at least one of the sub-frames, which is a predetermined number of sub-frames before the determined response start sub-frame and is allocated to the downlink,
wherein the user data is inserted into the determined transmission start sub-frame and is transmitted to the mobile terminal, and
the acknowledgement/negative-acknowledgement messages which are returned from the mobile terminal that has received the user data by the determined response start sub-frame are counted to calculate the throughput.

6. The mobile terminal test method according to claim 5,
wherein the step of determining the sub-frame as the sub-frame for starting the transmission of the user data used for the throughput test includes a step of storing information indicating the position of a sub-frame corresponding to the response start sub-frame from the response start sub-frame for each type of frame in advance.

7. The mobile terminal test method according to claim 5,
wherein the step of designating the type of frame used for the throughput test is a portion of a step of storing a scenario for defining an overall test procedure of the mobile terminal test method in advance and performing all processes of the mobile terminal test method according to the scenario, and designates the type of frame used for the throughput test according to the scenario.

8. The mobile terminal test method according to claim 5,
wherein the time division duplex system is a TD-LTE system.
